(19) United States
(12) Patent Application Publication
(10) Pub. No.: US 2009/0202901 A1
(43) Pub. Date: Aug. 13, 2009

(54) Battery

(75) Inventors: Monhiko Okuda, Shiga (JP); Hiroyuki Danno, Kyoto (JP); Oose Okutani, Kyoto (JP)

Correspondence Address: Kaplan Gilman & Pergament LLP, 1480 Route 9 North, Woodbridge, NJ, 07095, US

(73) Assignees: Sanyo Electric Co., Ltd., Osaka (JP); Sanyo GS Soft Energy Co., Ltd., Kyoto (JP)

(21) Appl. No.: 12/378,028

(22) Filed: Feb. 10, 2009

(30) Foreign Application Priority Data
Feb. 13, 2008 (JP) 2008-032240

(51) Int. Cl. H01M 2/04

(52) U.S. Cl. 429/175

(57) ABSTRACT

At a central portion of a lid of a battery, a negative terminal, which has a T-shaped section view, is provided so as to be surrounded by a gasket and pierce the lid. An insulator is provided at the inner face side of the lid. A plate-like current collector is placed in a recess of the insulator. Notches are provided at two positions of an insertion hole which is provided at one end portion side of the current collector. By inserting the negative terminal into the insertion hole and crimping an end portion of a leg portion of the negative terminal, the negative terminal is fixed to the current collector with a deforming part of the end portion eating into the notches and being locked.

### CROSS-REFERENCE TO RELATED APPLICATIONS

This Nonprovisional application claims priority under 35 U.S.C. §119(a) on Patent Application No. 2008-32240 filed in Japan on Feb. 13, 2008, the entire contents of which are hereby incorporated by reference.

### BACKGROUND

1. Technical Field

The present invention relates to a battery which is constructed by placing a battery element in a case and closing an opening of the case with a lid.

2. Description of Related Art

In recent years, reduction in size and weight and diversification of portable electronic devices, such as a video camera, a mobile computer and a mobile telephone, have caused a strong demand for development of a secondary battery to be used as power supply thereof, which is small and lightweight, has high energy density and high reliability such as storage stability, and can be repeatedly charged and discharged over long periods.

One of secondary batteries which fulfill such a demand is a nonaqueous electrolyte secondary battery containing a nonaqueous electrolyte therein.

A representative example of nonaqueous electrolyte secondary batteries is a lithium-ion secondary battery. The lithium-ion secondary battery comprises: a negative electrode made of active material which is capable of occlusion and emission of lithium ions; a positive electrode made of transition metal oxide, graphite fluoride and composite oxide which is composed of lithium and transition metal, or the like; and a nonaqueous electrolyte. The nonaqueous electrolyte is prepared by mixing lithium salt such as LiBF₄, LiPF₆, LiClO₄, LiAsF₆ or LiCF₃SO₃ into an aprotic organic solvent.

A lithium-ion secondary battery is constructed by placing flat-winding electrodes which are obtained by winding the positive electrode and the negative electrode via a separator in a case which is made of aluminum or aluminum alloy and has an opening on one face thereof, and closing the opening of the case with a lid which is made of aluminum or aluminum alloy.

FIG. 1 is a perspective view for illustrating a state where a lid 53 of a conventional lithium-ion secondary battery is seen from the reverse side.

At a central portion of the lid 53, a negative terminal 54 which comprises a tabular head portion 54a and a cylindrical leg portion 54b (see FIG. 2) and has a T-shaped section view is provided so as to pierce the lid 53, with the entire part other than the front face of the negative terminal 54 being surrounded by a gasket 55 made of synthetic resin.

An insulator 56 made of synthetic resin is provided at the reverse face of the lid 53. One end portion side of the lid 53 of the insulator 56 is longer than the other end portion side. The insulator 56 is provided with a recess 56a, in which a plate-like current collector 57 made of copper is placed. A negative lead, which is connected with a negative plate of the electrodes, is constructed to be connected with a tab 57b of the current collector 57.

FIG. 2 is a perspective view for illustrating a state where an end portion of the negative terminal 54 is crimped and jointed with the current collector 57. In the figure, the lid 53, the gasket 55 and the insulator 56 are omitted.

By inserting the leg portion 54b of the negative terminal 54 into an insertion hole 57a (FIG. 2A) and crimping (performing curling press) an end portion of the leg portion 54b, the negative terminal 54 is jointed with the current collector 57, i.e., connected electrically with the current collector 57 by a crimped portion 54c which has been formed (FIG. 2B), and fixed to the lid 53 via the current collector 57 and the insulator 56.

As illustrated in FIG. 2B, the contact state of the substantially disk-shaped crimped portion 54c and the circular insertion hole 57a is weak against rotation stress with respect to the central axis of the insertion hole 57a. Accordingly, when the lithium-ion secondary battery falls or the like and is subject to a shock, there is a problem that the crimped portion 54c rotates, causing deterioration of the contact state of the negative terminal 54 and the current collector 57 and a rise in contact resistance.

In order to solve such a problem, the x-ed parts illustrated in FIG. 2 are sometimes welded. However, there are a problem that addition of a welding process complicates the processes and a problem that thermal energy of welding may melt a part of the insulator 56, causing deterioration of sealing performance of the lid 53 by the insulator 56 and leakage of the nonaqueous electrolyte.

Disclosed in Japanese Utility Model Application Laid-Open No. H5-31108 is invention of a battery which is constructed by inserting a rivet into a lid of the battery with a gasket being interposed therebetween, crimping the rivet at the inner face side of the lid via the gasket and a washer, and providing a projection at a rim of a rivet insertion hole at the outer face of the washer or at the inner face of a head portion of the rivet. Such a structure makes it possible to prevent leakage of an electrolytic solution.

Disclosed in Japanese Patent Application Laid-Open No. 2003-45404 is invention of a battery which is constructed by disposing an electrode extraction plate at the outer face of a lid via an insulator, inserting an electrode leading pin into the lid, crimping an outer end portion of the electrode leading pin at the electrode extraction plate, and providing an annular projection at a rim portion of an insertion hole of the electrode extraction plate. Such a structure makes it possible to improve conductive contact of the electrode leading pin and the electrode extraction plate.

Disclosed in Japanese Utility Model Application Laid-Open No. H7-27051 is invention of a battery wherein a head portion and a leg portion of a rivet terminal are formed to have oval planar views so as to shorten the distance from a boundary part between the leg portion and the head portion to a longitudinal end portion of the head portion. In such a battery, the end portion is kept from lifting while the leg portion is crimped to the inner face of the lid via a lead member, and occurrence of poor weld in welding of a terminal cap at the head portion is inhibited.

Disclosed in Japanese Patent Application Laid-Open No. H6-231740 is invention of a battery which is constructed by inserting a rivet terminal constructed of a head portion and a leg portion into a lid, crimping the leg portion at the outer face side of the lid via the first washer, fixing the head portion at the inner face side of the lid via the second washer, and welding a contact part of the head portion and the second washer. Such a structure makes it possible to inhibit occurrence of contact failure.

### SUMMARY

In the battery of the Japanese Utility Model Application Laid-Open No. H5-31108 mentioned above, distortion may occur at the contact part of a crimped part of the rivet and the washer and contact failure may occur when a shock is applied by fall of the battery or the like, though rotation of the rivet is inhibited.

In the battery of the Japanese Patent Application Laid-Open No. 2003-45404 wherein a projection is continuously provided annularly at the edge of the electrode extraction plate, there is a problem that contact failure may occur when a shock is applied to the battery, since the electrode leading pin tends not to bite into the electrode extraction plate side when the outer end portion of the electrode leading pin is crimped to the electrode extraction plate, and the electrode leading pin tends to rotate with respect to the annular projection.

In the battery of the Japanese Utility Model Application Laid-Open No. H7-27051 wherein the leg portion of the rivet terminal has an oval planar view and a long perimeter and the distance from the central axis differs according to the position in a rim of the leg portion, it is difficult to realize uniform crimp and contact failure may occur between the leg portion and the lead member.

In the battery of the Japanese Patent Application Laid-Open No. H6-231740, there is a problem that addition of a welding process complicates the processes as mentioned above, and thermal energy of welding may melt a part of the lid made of synthetic resin, causing deterioration of contact performance of the lid and the washer and deterioration of sealing performance or the like against the nonaqueous electrolyte.

The present aspect has been made in view of such circumstances, and it is an objet thereof to provide a battery wherein a joint part of a current collector and a terminal is provided with a rotation inhibition structure for inhibiting rotation of the terminal, so that the contact state of the current collector and the terminal can be stabilized without employing weld, occurrence of contact failure and a rise in contact resistance are inhibited when a shock is applied by fall or the like, and favorable quality and sealing performance are realized.

A battery according to the first aspect is a battery comprising: a terminal which is provided at a lid of a battery case so as to pierce the lid; a current collector which is provided with an insertion hole that allows the terminal to be inserted therein, is disposed at an inner face side of the lid and is jointed with the terminal by crimping an end portion of the terminal that is inserted into the insertion hole; and an insulator which is interposed between the terminal, the current collector and the lid, wherein a joint part of the current collector and the terminal is provided with a rotation inhibition structure.

In the present aspect wherein the joint part of the current collector and the terminal is provided with the rotation inhibition structure, rotation of the terminal is inhibited when a shock is applied by fall or the like, and occurrence of contact failure is inhibited.

Moreover, unlike in the case where a crimped part of the current collector and the terminal is welded so as to inhibit rotation, deformation does not occur at an insulator member, which is attached to the lid, or the like and sealing performance of the lid is ensured.

A battery according to the second aspect is the battery of the first aspect, characterized in that the rotation inhibition structure is constructed by plural notches which are provided at a rim of the insertion hole of the current collector.

In the present aspect wherein a deforming part of an end portion of the terminal bites into the notches and the deforming part is locked at the notches when the terminal is crimped to the current collector, rotation of the terminal is inhibited favorably.

A battery according to the third aspect is the battery of the first aspect, characterized in that the rotation inhibition structure is constructed by plural projections which are provided along a rim of the insertion hole of the current collector so as to project toward an inner face side of the current collector.

In the present aspect wherein projections are formed discontinuously at a rim of the insertion hole, an end portion of the terminal bites into the current collector side from a gap between projections and the projections deform to bite into an end portion of the terminal when the terminal is crimped so as to fix to the current collector and a crimped part is formed. Accordingly, the end portion is locked at the projections favorably and attached firmly to the current collector favorably, and rotation of the terminal is inhibited favorably.

A battery according to the fourth aspect is the battery of the first aspect, characterized in that the rotation inhibition structure is constructed by: plural notches which are provided at a rim of the insertion hole of the current collector; and plural projections which are provided between the notches along the rim so as to project toward an inner face side of the current collector.

In the present aspect wherein a deforming part of an end portion of the terminal bites into the notches and the projections bite into the deforming part of the end portion when the terminal is crimped to the current collector, a crimped part is locked at the notches and the projections an is attached firmly to the current collector favorably. Accordingly, rotation of the crimped part with respect to the central axis of the insertion hole is inhibited favorably.

A battery according to the fifth aspect is the battery of the first aspect, characterized in that the rotation inhibition structure is constructed by forming the insertion hole to have a polygonal shape.

In the present aspect wherein a hole of the current collector, which allows the terminal to be inserted therein, is not a circular hole but has a polygonal shape, a deforming part of an end portion of the terminal bites into the corners of the hole and the deforming part is locked at the corners when the terminal is crimped to the current collector, and rotation of the terminal is inhibited favorably.

A battery according to the sixth aspect is the battery of the fifth aspect, characterized in that the rotation inhibition structure is constructed by forming a part of the terminal which is to be inserted into the insertion hole to have a polygonal cylinder shape.

In the present aspect wherein a part of the terminal which is to be inserted into the insertion hole also has a polygonal shape, an end portion of the terminal is locked at the corners of the insertion hole more favorably when the terminal is crimped to the current collector, and rotation of the terminal is inhibited more favorably for the further reason that a polygonal cylinder cannot rotate with respect to a polygonal hole.

A battery according to the seventh aspect is the battery of any one of the first to sixth aspects, characterized in that a nonaqueous electrolyte is contained.

In the present aspect wherein the lid has favorable sealing performance, leakage of the nonaqueous electrolyte contained in the battery is inhibited favorably.

With the present aspect, a joint part of the current collector and the terminal is provided with a rotation inhibition structure which attaches the current collector and the terminal firmly to each other and inhibits rotation of the terminal, the contact state is stabilized, and occurrence of contact failure and a rise in contact resistance are inhibited when a shock is applied by fall of the battery, or the like.

Moreover, processes are not complicated unlike in the case where a crimped part of the current collector and the terminal is further welded so as to inhibit rotation, and quality and sealing performance of the case are favorable and leakage of content such as a nonaqueous electrolyte is inhibited since deformation does not occur at an insulator which is attached to the lid, or the like.

Furthermore, since a part of the terminal which is to be inserted into the insertion hole is constructed to have a substantially cylindrical shape or constructed as a cylinder having a substantially regular polygonal planar view, uniform crimp is realized and occurrence of contact failure between the current collector and the terminal at the time of crimping can be inhibited.

The above and further objects and features will more fully be apparent from the following detailed description with accompanying drawings.

### BRIEF DESCRIPTION OF THE SEVERAL VIEWS OF THE DRAWINGS

FIG. 1 is a perspective view for illustrating a state where a lid of a conventional battery is seen from the reverse side;

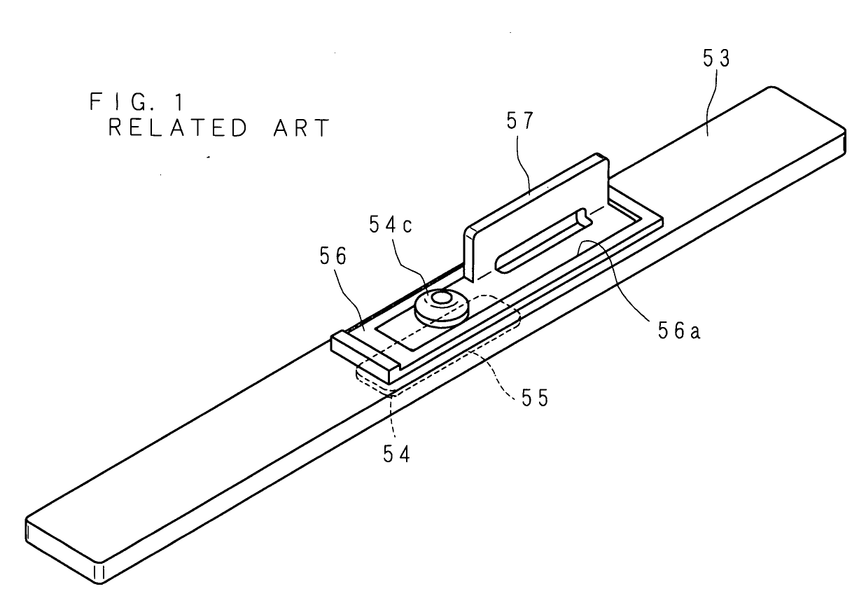

FIG. 2 is a perspective view for illustrating a state where an end portion of a negative terminal of a conventional battery is crimped and jointed with a current collector;

FIG. 3 is a perspective view for illustrating a battery according to Embodiment 1;

FIG. 4 is a perspective view for illustrating a state where a lid of a battery according to Embodiment 1 is seen from the reverse side;

FIG. 5 is a partially sectional side view for illustrating a lid according to Embodiment 1;

FIG. 6 is a perspective view for illustrating a current collector according to Embodiment 1;

FIG. 7 is a perspective view for illustrating a state where an end portion of a negative terminal according to Embodiment 1 is crimped and jointed with a current collector;

FIG. 8 is a vertical sectional view for illustrating an essential portion of a lid according to Embodiment 1;

FIG. 9 is a perspective view for illustrating a state where an end portion of a negative terminal according to Embodiment 2 is inserted into an insertion hole of a current collector;

FIG. 10 is a vertical sectional view for illustrating an essential portion of a lid according to Embodiment 2;

FIG. 11 is a perspective view for illustrating a state where an end portion of a negative terminal according to Embodiment 3 is inserted into an insertion hole of a current collector;

FIG. 12 is a perspective view for illustrating a state where an end portion of a negative terminal according to Embodiment 4 is inserted into an insertion hole of a current collector;

FIG. 13 is a perspective view for illustrating a state where an end portion of a negative terminal according to Embodiment 5 is inserted into an insertion hole of a current collector; and

FIG. 14 is a table for illustrating a result of a drop test.

### DETAILED DESCRIPTION

The following description will explain the present embodiments in the concrete with reference to the drawings.

### Embodiment 1

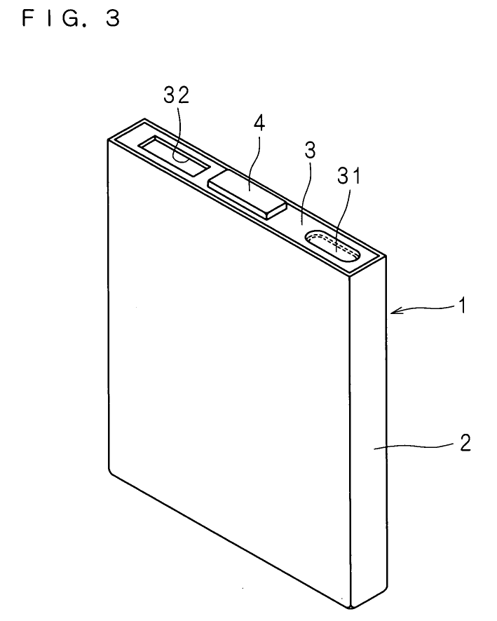

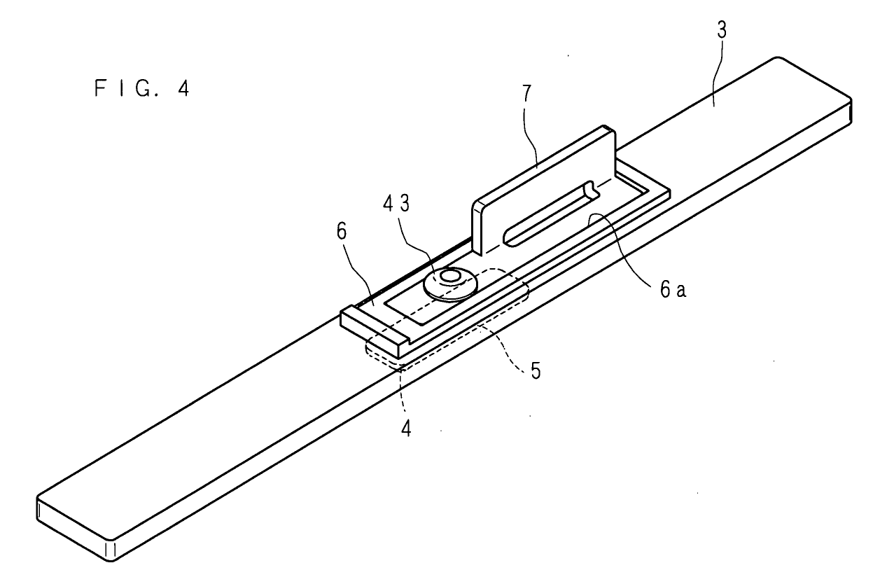

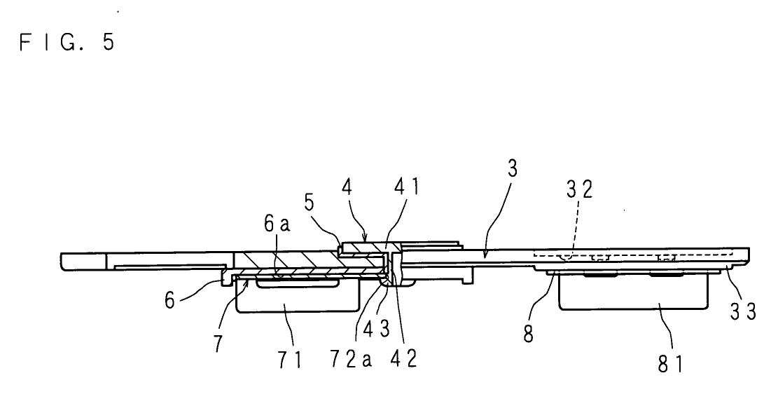

FIG. 3 is a perspective view for illustrating a lithium-ion secondary battery (which will be hereinafter referred to as a battery) 1 according to Embodiment 1; FIG. 4 is a perspective view for illustrating a state where a lid 3 of the battery 1 is seen from the reverse side; and FIG. 5 is a partially sectional side view for illustrating the lid 3. In FIG. 4, a member to be connected with a recess 32 which will be described later is omitted.

The battery 1 is constructed by placing flat-winding electrodes which are obtained by winding a negative plate made by coating a copper current collector with negative mixture and a positive plate made by coating an aluminum current collector with positive mixture via a separator, and a nonaqueous electrolyte (not illustrated) in a case 2 which is made of aluminum and has a substantially rectangular parallelepiped shape with an opening provided on one face thereof, and closing the opening of the case 2 with the lid 3 which is made of aluminum.

Provided at one end portion of the lid 3 is a safety rupture valve 31 which has thickness less than that of the rest part and has an oval planar view so as to diffuse the pressure when the internal pressure of the battery 1 rises abnormally. A recess 32 having a rectangular planar view is provided at the other end portion of the lid 3, and a projection 33 is provided below the recess 32.

At a central portion of the lid 3, a negative terminal 4 which comprises a tabular head portion 41 and a cylindrical leg portion 42 and has a T-shaped sectional view, is provided so as to pierce the lid 3, with the entire part other than the front face of the negative terminal 4 being surrounded by a gasket 5 which is made of synthetic resin. The negative terminal 4 is made of a nickel-plated steel product and has been subject to annealing after processing. The negative terminal 4 may be made of nickel material. A part of the battery 1 other than a part where the negative terminal 4 of the case 2 is provided becomes a positive electrode (terminal).

At a reverse face of the lid 3, an insulator 6 made of synthetic resin is provided. One end portion side of the lid 3 of the insulator 6 is longer than the other end portion side. The insulator 6 is provided with a recess 6a, in which a plate-like current collector 7 made of copper is placed. A negative lead connected to the negative plate of the electrodes is connected to a tab 71 of the current collector 7. The current collector 7 may be made of nickel material or a nickel-plated steel product.

The insulator 6 and the current collector 7 are respectively provided with an insertion hole which allows the leg portion 42 of the negative terminal 4 to be inserted therein.

A plate-like current collector 8 made of aluminum is connected with the projection 33. A positive lead connected with the positive plate of the electrodes is connected with a tab 81 of the current collector 8.

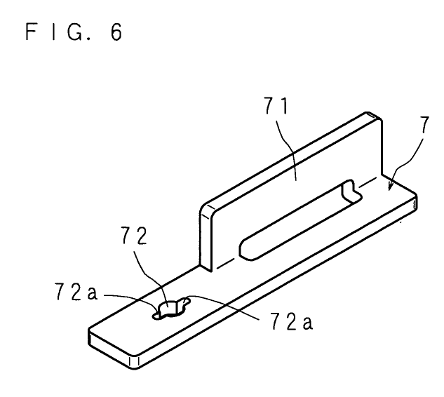

FIG. 6 is a perspective view for illustrating the current collector 7.

As illustrated in FIG. 6, substantially semicircular notches 72a, 72a, which have a radius corresponding to approximately one third of the radius of an insertion hole 72, are provided at two positions of the circular insertion hole 72 which is provided at one end portion of the current collector 7, in a direction corresponding with the longitudinal direction of the current collector 7.

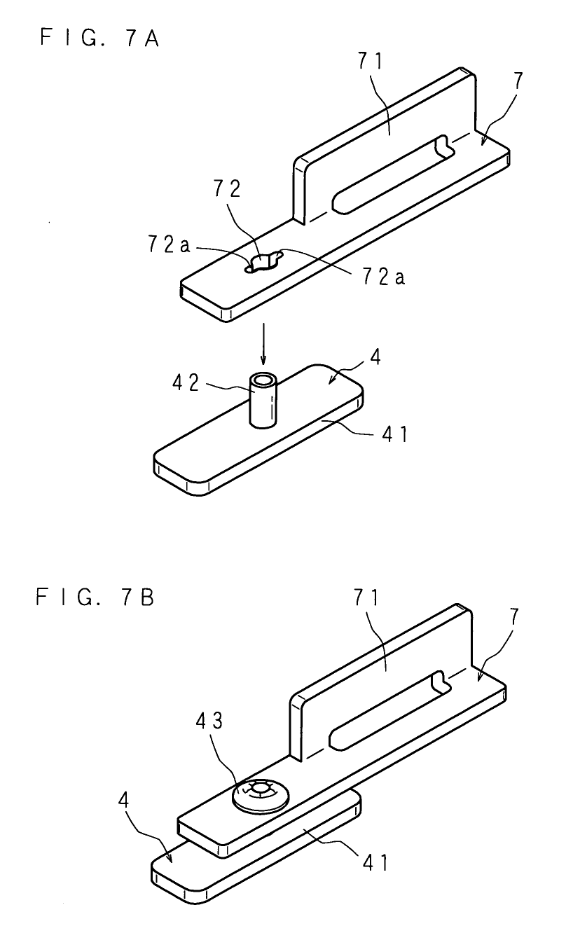

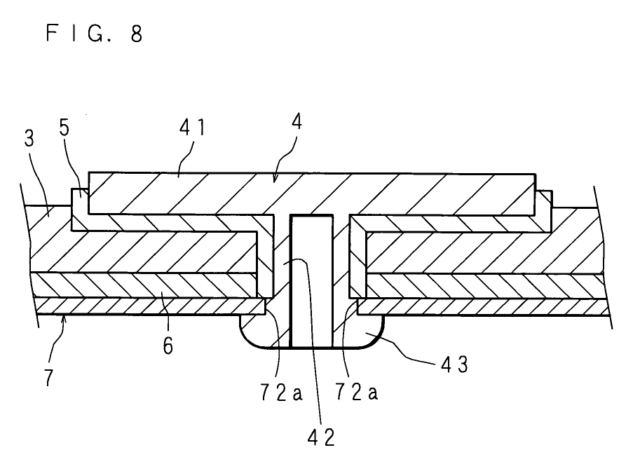

FIG. 7 is a perspective view for illustrating a state where an end portion of the negative terminal 4 is crimped and jointed with the current collector 7; and FIG. 8 is a vertical sectional view for illustrating an essential portion of the lid 3. In FIG. 7, the lid 3, the gasket 5 and the insulator 6 are omitted.

By inserting the negative terminal 4 into the insertion hole 72 (FIG. 7A) and crimping an end portion of the leg portion 42 of the negative terminal 4, a crimped portion 43 is formed and the negative terminal 4 is fixed to the current collector 7 (FIG. 7B).

As illustrated in FIG. 8, when the leg portion 42 is squashed, a deforming part of the leg portion 42 bites into the notches 72a, 72a and is locked at the notches 72a, 72a, and therefore the crimped portion 43 is attached firmly to the current collector 7 favorably. Accordingly, rotation of the crimped portion 43 with respect to the central axis of the insertion hole 72 is inhibited. Moreover, since the leg portion 42 has a cylindrical shape, uniform crimp is realized and occurrence of contact failure between the current collector 7 and the negative terminal 4 at the time of crimping is also inhibited.

As described above, in the present embodiment wherein a joint part of the negative terminal 4 and the current collector 7 is provided with a rotation inhibition structure constructed of the notches 72a, 72a, the contact state of the negative terminal 4 and the current collector 7 is stabilized, and occurrence of contact failure between the negative terminal 4 and the current collector 7 and a rise in contact resistance are inhibited when a shock is applied by fall of the battery 1, or the like.

Moreover, it is unnecessary to weld the current collector 7 and the crimped portion 43 so as to inhibit rotation, deformation does not occur at the insulator 6, which is attached to the lid 3, or the like, and the battery 1 has favorable quality and sealing performance.

It is to be noted that the number, the shape and the size of the notches 72a to be provided at the insertion hole 72 are not limited to the number, the shape and the size explained in the present embodiment.

### Embodiment 2

A battery according to Embodiment 2 has a structure similar to that of the battery 1 according to Embodiment 1, except that a rotation inhibition structure at a joint part of a negative terminal 14 and a current collector 11 is different from the rotation inhibition structure of Embodiment 1.

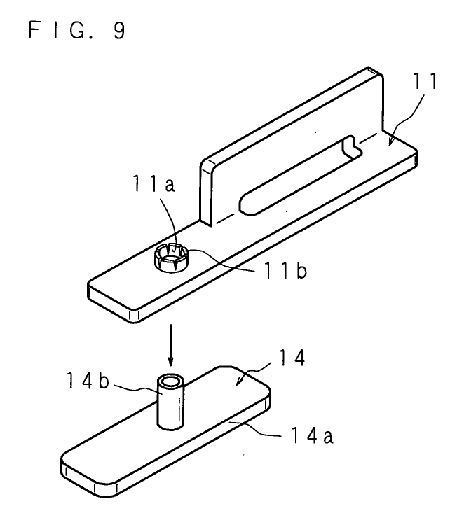

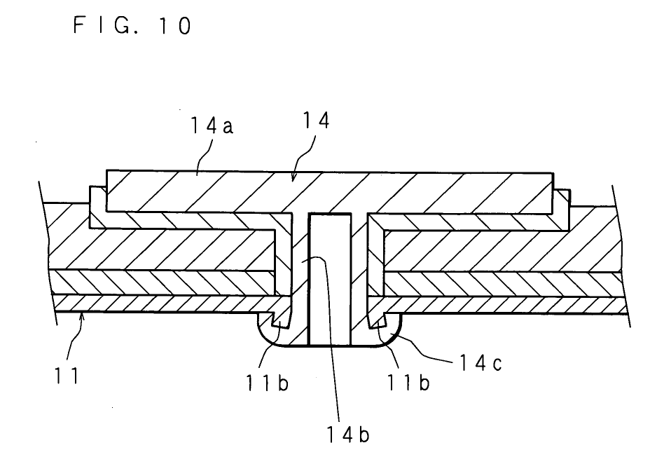

FIG. 9 is a perspective view for illustrating a state where an end portion of a negative terminal 14 is inserted into an insertion hole 11a of a current collector 11; and FIG. 10 is a vertical sectional view for illustrating an essential portion of a lid of the battery.

As illustrated in FIG. 9, at the current collector 11, projections 11b, 11b, . . . are provided along a rim of the insertion hole 11a so as to project toward the inner face side of the current collector 11.

When an end portion of the leg portion 14b of the negative terminal 14 is inserted into the insertion hole 11a and the end portion is crimped to the current collector 11, as illustrated in FIG. 10 the projections 11b, 11b, . . . bite into a crimped portion 14c which is obtained by deformation of the end portion, and the crimped portion 14c is locked at the projections 11b, 11b, . . . . Since the projections 11b, 11b, . . . are formed discontinuously at the rim of the insertion hole 11a, an end portion of the leg portion 14b can eat deeply into the current collector 11 side when the leg portion 14b is crimped to the current collector 11, unlike in the case where a projection is formed annularly at the rim of the insertion hole 11a. With the structure described above, the crimped portion 14c is attached firmly to the current collector 11 favorably, and rotation of the crimped portion 14c with respect to the central axis of the insertion hole 11a is inhibited.

In the present embodiment which is provided with a rotation inhibition structure constructed of plural projections 11b described above, the contact state of the negative terminal 14 and the current collector 11 is stabilized, and occurrence of contact failure between the negative terminal 14 and the current collector 11 is inhibited even when a shock is applied to the battery.

### Embodiment 3

A battery according to Embodiment 3 has a structure similar to that of the battery 1 according to Embodiment 1, except that a joint part of a negative terminal 4 and a current collector 12 is provided with a rotation inhibition structure obtained by combining the rotation inhibition structure of Embodiment 1 and the rotation inhibition structure of Embodiment 2.

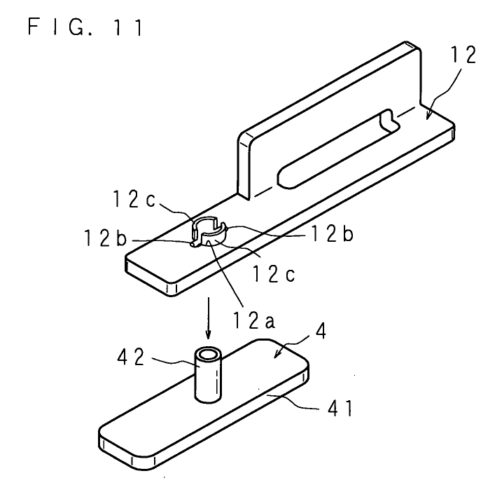

FIG. 11 is a perspective view for illustrating a state where an end portion of the negative terminal 4 is inserted into an insertion hole 12a of a current collector 12.

As illustrated in FIG. 11, substantially semicircular notches 12b, 12b are provided at the insertion hole 12a of the current collector 12 like the current collector 7 according to Embodiment 1, and semi-annular projections 12c, 12c are further provided so as to face each other with the notches 12b, 12b being interposed therebetween.

In such a structure, when an end portion of the leg portion 42 of the negative terminal 4 is inserted into the insertion hole 12a and the end portion is crimped to the current collector 12, a deforming part of the end portion bites into the notches 12b, 12b and the projections 12c, 12c bite into the deforming part of the end portion, and therefore the crimped portion is locked at the notches 12b, 12b and the projections 12c, 12c. Since the projections 12c, 12c are formed discontinuously at the rim of the insertion hole 12a, an end portion of the negative terminal 4 can eat deeply into the current collector 12 side when the negative terminal 4 is crimped to the current collector 12, unlike in the case where a projection is formed annularly at the rim of the insertion hole 12a. With the structure described above, the crimped portion is attached firmly to the current collector 12 favorably and rotation of the crimped portion with respect to the central axis of the insertion hole 12a is inhibited further favorably.

In the present embodiment wherein a joint part of the negative terminal 4 and the current collector 12 is provided with a rotation inhibition structure constructed of the notches 12b and the projections 12c, the contact state of the negative terminal 4 and the current collector 12 is stabilized, and occurrence of contact failure between the negative terminal 4 and the current collector 12 is inhibited even when a shock is applied to the battery.

### Embodiment 4

A battery according to Embodiment 4 has a structure similar to that of the battery 1 according to Embodiment 1, except that a rotation inhibition structure at a joint part of a negative terminal 4 and a current collector 13 is different from the rotation inhibition structures of Embodiments 1 to 3.

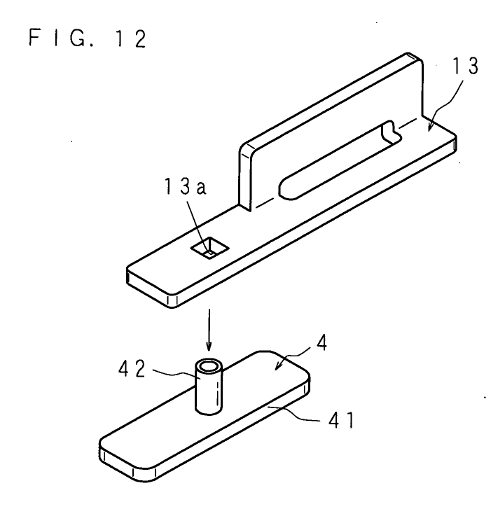

FIG. 12 is a perspective view for illustrating a state where an end portion of the negative terminal 4 is inserted into an insertion hole 13a of a current collector 13.

The insertion hole 13a of the current collector 13 according to Embodiment 4 is not a circular hole as illustrated in FIG. 11, but is constituted of a square hole having a substantially square planar view.

In such a structure, when an end portion of a leg portion 42 of the negative terminal 4 is inserted into the insertion hole 13a and the end portion is crimped to the current collector 13, a deforming part of the end portion bites into the corners of the insertion hole 13a and is locked at the corners, and therefore the crimped portion is attached firmly to the current collector 13 favorably. Accordingly, rotation of the crimped portion with respect to the central axis of the insertion hole 13a is inhibited favorably.

In the present embodiment wherein a joint part of the negative terminal 4 and the current collector 13 is provided with a rotation inhibition structure constituted of the square insertion hole 13a, the contact state of the negative terminal 4 and the current collector 13 is stabilized, and occurrence of contact failure between the negative terminal 4 and the current collector 13 is inhibited even when a shock is applied to the battery.

It is to be noted that the present invention is not limited to the description of the embodiment explaining a case where the insertion hole 13a has a substantially square planar view, and the insertion hole may have other polygonal planar view, such as regular hexagon or regular octagon.

In addition to the feature that the insertion hole 13a has the polygonal planar view, notches may be provided at the insertion hole 13a as in Embodiment 1, or projections may be provided at the insertion hole 13a as in Embodiment 2.

### Embodiment 5

A battery according to Embodiment 5 has a structure similar to that of the battery 1 according to Embodiment 1. A rotation inhibition structure at a joint part of a negative terminal 15 and a current collector 13 of Embodiment 5 is a modification example of the rotation inhibition structure of Embodiment 4.

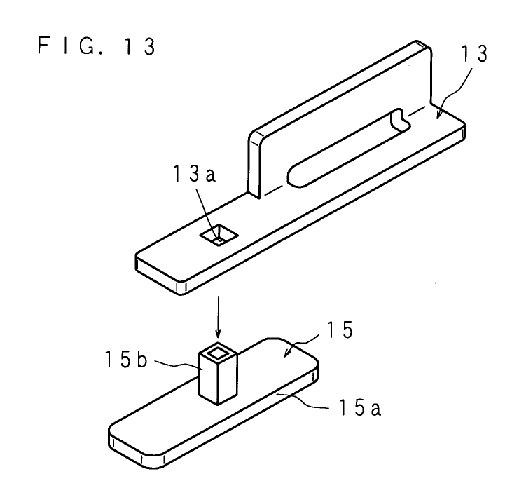

FIG. 13 is a perspective view for illustrating a state where an end portion of the negative terminal 15 is inserted into an insertion hole 13a of the current collector 13. In the figure, same codes are used to refer to same parts in FIG. 12 and detailed explanation is omitted.

The negative terminal 15 according to Embodiment 5 comprises a tabular head portion 15a and a square cylindrical leg portion 15b which has a substantially square planar view.

In such a structure, when an end portion of the leg portion 15b of the negative terminal 15 is inserted into the insertion hole 13a and the end portion is crimped to the current collector 13, a deforming part of the end portion bites into the corners of the insertion hole 13a, and the crimped portion is locked at the corners and therefore is attached firmly to the current collector 13 favorably. Accordingly, rotation of the crimped portion with respect to the central axis of the insertion hole 13a is inhibited favorably for the further reason that a square cylinder inserted into a square hole cannot rotate with respect to the square hole.

In the present embodiment wherein a joint part of the negative terminal 15 and the current collector 13 is provided with a rotation inhibition structure constructed of the square insertion hole 13a and the square cylindrical leg portion 15b, the contact state of the negative terminal 15 and the current collector 13 is stabilized, and occurrence of contact failure between the negative terminal 15 and the current collector 13 is inhibited even when a shock is applied to the battery.

It is to be noted that the present invention is not limited to the description of the present embodiment explaining a case where the insertion hole 13a has the substantially square planar view and the leg portion 15b of the negative terminal 15 is the square cylinder having the substantially square planar view. The insertion hole and the leg portion of the negative terminal may have other polygonal planar view, such as regular hexagon or regular octagon, and the shape of the insertion hole and the planar shape of the leg portion may not coincide with each other.

In addition to the feature that the insertion hole 13a has a polygonal shape and the leg portion 15b has a polygonal planar view, notches may be provided at the insertion hole 13a as in Embodiment 1, or projections may be provided at the insertion hole 13a as in Embodiment 2.

### EXAMPLES

The following description will explain the present invention using suitable examples, though the present invention is not limited by the present examples in any way and can be implemented in a suitably modified manner without departing from the scope of the invention.

### Example 1

A battery having the same structure as that of the battery 1 according to the Embodiment 1 was prepared as Example 1.

A positive plate was prepared as follows.

LiCoO₂ particles having a mean particle diameter of 3 μm as positive active material, acetylene black (AB) as conductive assistant, and polyvinylidene fluoride (PVDF) as binder were mixed in LiCoO₂/AB/PVDF=94/3/3 (mass fraction) to obtain positive mixture, and positive paste was prepared by dispersing the positive mixture in N-methyl-2-pyrrolidone (NMP).

Both faces of a positive current collector, which is made of aluminum and has thickness of 13 μm were coated uniformly with the above positive paste by a doctor blade in such a manner that the mass of positive mixture excluding NMP at one face becomes 0.020 g/cm², and then the positive current collector was dried at 150° C. for one hour. Then the positive current collector was pressed to have thickness of 130 μm at room temperature and the positive plate having positive mixture layers formed at both faces of the positive current collector was obtained.

A negative plate was prepared as follows.

Graphite (black lead) as negative active material, and PVDF as binder were mixed in mass ratio of 90:10 to obtain negative mixture, and negative paste was obtained by adding appropriate quantities of NMP and dispersing the negative mixture.

Both faces of a negative current collector, which is made of copper and has a thickness of 6 μm were coated uniformly with the above negative paste by a doctor blade in such a manner that the mass of the negative mixture excluding NMP at one face becomes 0.0095 g/cm², and then the negative current collector was dried at 150° C. for one hour. Then the negative current collector was pressed to have thickness of 145 μm at room temperature and the negative plate was obtained.

As a separator, a microporous membrane which is made of polyethylene and has a thickness of approximately 16 μm was used.

Electrodes were prepared by winding the positive plate and the negative plate, with the separator being interposed therebetween.

As a nonaqueous electrolyte, a solution obtained by dissolving 1.1 mol/L LiPF₆ in a 3/7 mixed solvent (by volume) of ethylene carbonate and diethyl carbonate was used.

Next, a negative terminal 4 according to the Embodiment 1 was crimped to a current collector 7 and fixed to a lid 3, and a negative lead and a positive lead of the electrodes were connected respectively to tabs 71, 81 of the current collectors 7, 8. The electrodes connected to the lid 3 were then placed in a case 2 and the lid 3 was fixed to the opening of the case 2 and welded to the case 2. A battery 1 was prepared by further injecting the nonaqueous electrolyte from an inlet hole and sealing the inlet hole.

The battery 1 had a length of 50 mm, a width of 34 mm, and a thickness of 4 mm. A leg portion 42 of the negative terminal 4 had an outside diameter of 1 mm and a thickness of 0.15 mm. The current collector 7 had a thickness of 0.2 mm, the inside diameter of an insertion hole 72 was 1.05 mm, and the diameter of notches 72a, 72a was 0.15 mm.

### Example 2

A battery was prepared in a manner similar to that of Example 1 except that a current collector 11 according to the Embodiment 2 was used as a current collector, a negative terminal 14 according to the Embodiment 2 was used as a negative terminal, and the negative terminal 14 was crimped to the current collector 11.

A projection 11b of the current collector 11 had a width of 0.4 mm, a projection length of 0.2 mm, and a thickness of 0.2 mm.

### Example 3

A battery was prepared in a manner similar to that of Example 1 except that a current collector 12 according to the Embodiment 3 was used as a current collector and a negative terminal 4 was crimped to the current collector 12.

The inside diameter of an insertion hole 12a of the current collector 12 was 1.05 mm, and the diameter of notches 12b, 12b was 0.15 mm. Projections 12c had a circular length of 1.35 mm, a projection length of 0.2 mm, and a thickness of 0.2 mm.

### Example 4

A battery was prepared in a manner similar to that of Example 1 except that a current collector 13 according to the Embodiment 4 was used as a current collector and a negative terminal 4 was crimped to the current collector 13.

The length of one side of an insertion hole 13a of the current collector 13 was 1.05 mm.

### Example 5

A battery was prepared in a manner similar to that of Example 1 except that a current collector 13 according to the Embodiment 5 was used as a current collector, a negative terminal according to the Embodiment 5 was used as a negative terminal, and the negative terminal 15 was crimped to the current collector 13.

The length of one side of a leg portion 15b of the negative terminal 15 was 1 mm.

### Comparative Example

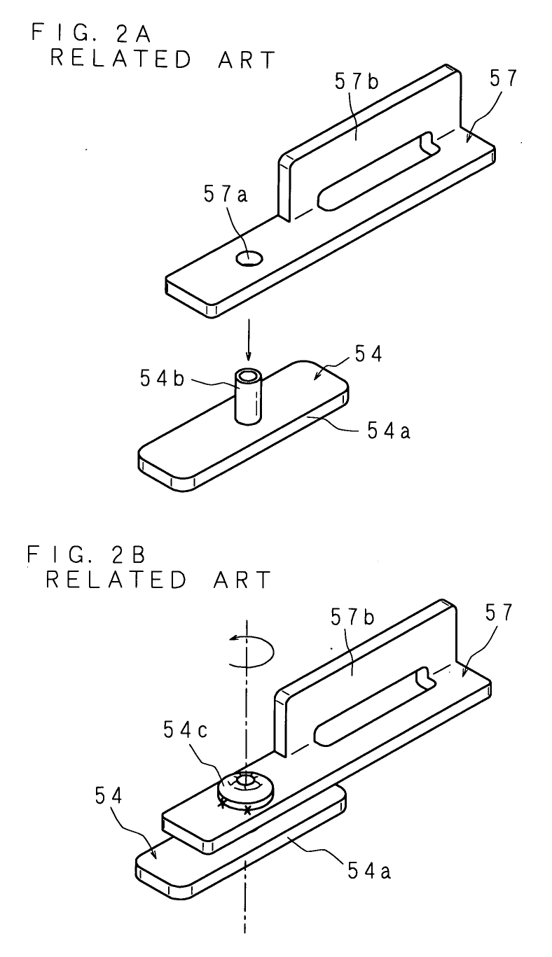

A battery was prepared in a manner similar to that of Example 1 except that a current collector 57 illustrated in FIG. 2 was used as a current collector and a negative terminal 54 was crimped to the current collector 57.

Drop Test of Battery

Ten batteries were prepared for each of Examples 1 to 5 and the comparative example, and the following drop test was performed.

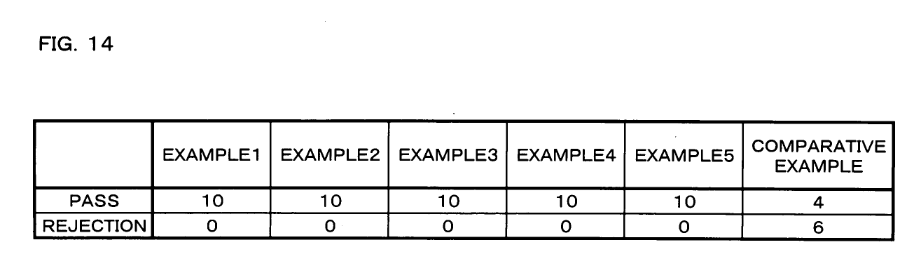

Drop test was carried out by causing a battery to fall freely from a height of 1.5 m to a concrete face. The internal resistance of each battery was measured after free fall of ten cycles, one cycle including six times of fall with each of the six faces of a battery being faced downward by turns. A battery was determined as a rejection when a resistance rise with respect to an initial value was equal to or larger than 10 mΩ, and a battery was determined as a pass when such a resistance rise did not occur. The result of such a drop test is illustrated in the table of FIG. 14. Each number in the table denotes the number of batteries.

It is to be understood that all batteries in Examples 1 to 5 passed the drop test, while the contact state in 60 percent of batteries in the comparative example was deteriorated, causing a rise in contact resistance.

It was recognized from the above test that the contact state of the current collector and the negative terminal of each of the present examples was stabilized and occurrence of contact failure and a rise in contact resistance were inhibited when a shock was applied by fall of a battery, since a joint part of the current collector and the negative terminal was provided with a rotation inhibition structure for inhibiting rotation of the negative terminal.

It is to be noted that the present invention is not limited to the description of the Embodiments 1 to 5 explaining a case where a battery 1 is a lithium-ion secondary battery wherein a negative terminal is inserted into the lid 3. A rotation inhibition structure according to the present invention may be applied to a joint part of a positive terminal and a current collector in a battery wherein the positive terminal is inserted into a lid. In such a case, a case is made of iron, the current collector is made of aluminum, and the positive terminal is made of aluminum.

Moreover, the present invention is not limited to the description of the Embodiments 1 to 5 explaining a case where a case 2 has a substantially rectangular parallelepiped shape. A rotation inhibition structure of the present invention may be applied to a substantially rectangular lithium-ion secondary battery which is constructed in such a manner that the opening face of the case 2 has an oval shape, i.e., the narrow side face of the case 2 is a curved surface, or may be applied to a cylindrical lithium-ion secondary battery.

Furthermore, a rotation inhibition structure of the present invention may be applied to other secondary batteries such as a nickel-hydrogen secondary battery or a nickel-cadmium secondary battery, or may be applied to a primary battery.

As this description may be embodied in several forms without departing from the spirit of essential characteristics thereof, the present embodiments are therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

1. A battery comprising:
a terminal which is provided at a lid of a battery case so as to pierce the lid;
a current collector which is provided with an insertion hole that allows the terminal to be inserted therein, is disposed at an inner face side of the lid and is jointed with the terminal by crimping an end portion of the terminal that is inserted into the insertion hole; and
an insulator which is interposed between the terminal, the current collector and the lid,
wherein a joint part of the current collector and the terminal is provided with a rotation inhibition structure.

2. The battery according to claim 1, wherein the rotation inhibition structure is constructed by plural notches which are provided at a rim of the insertion hole of the current collector.

3. The battery according to claim 1, wherein the rotation inhibition structure is constructed by plural projections which are provided along a rim of the insertion hole of the current collector so as to project toward an inner face side of the current collector.

4. The battery according to claim 1, wherein the rotation inhibition structure is constructed by:
plural notches which are provided at a rim of the insertion hole of the current collector; and
plural projections which are provided between the notches along the rim so as to project toward an inner face side of the current collector.

5. The battery according to claim 1, wherein the rotation inhibition structure is constructed by forming the insertion hole to have a polygonal shape.

6. The battery according to claim 5, wherein the rotation inhibition structure is constructed by forming a part of the terminal which is to be inserted into the insertion hole to have a polygonal cylinder shape.

7. The battery according to claim 1, wherein a nonaqueous electrolyte is contained.

8. The battery according to claim 2, wherein a nonaqueous electrolyte is contained.

9. The battery according to claim 3, wherein a nonaqueous electrolyte is contained.

10. The battery according to claim 4, wherein a nonaqueous electrolyte is contained.

11. The battery according to claim 5, wherein a nonaqueous electrolyte is contained.

12. The battery according to claim 6, wherein a nonaqueous electrolyte is contained.
